(19) United States
(12) Patent Application Publication
(10) Pub. No.: US 2009/0134662 A1
(43) Pub. Date: May 28, 2009

(54) Scissor style pivoting vehicle door

(76) Inventor: Simon Gojcaj, Sterling Heights, MI (US)

Correspondence Address: RUTH EURE, 4795 EDISON AVENUE, BOULDER, CO, 80301, US

(21) Appl. No.: 11/986,890

(22) Filed: Nov. 27, 2007

(51) Int. Cl. B60J 5/04

(52) U.S. Cl. 296/146.11

(57) ABSTRACT

A vehicle door that opens from a point of rotation in a scissors like motion is provided. When the door is unlatched, it moves away from the side of the vehicle and swivels upward in a scissors like motion traveling along an arcuate path which parallels the curvature of the vehicle. It is suitable for use with any vehicles including four door sedan, two door coupe, two or four door convertible, pick-up truck, van, minivan and minibus.

### FIELD OF THE INVENTION

The present invention relates to the field of vehicle doors, and more specifically to automobile doors.

### BACKGROUND OF THE INVENTION

Most car doors on automobiles in use today open outward. This requires additional space to accommodate the width of the door in addition to the width of the automobile. The problem of car doors opening outward into traffic, outward onto crowded sidewalks and in crowded parking lots has increased with the number of cars in use today. Several solutions have been put forward by the prior art. Examples of such solutions are found in the following U.S. patents.

U.S. Pat. No. 4,801,172 to “Vehicle Closure” describes displaceable panel apertures formed in generally curved exterior walls and multipart aperture closures where the lower part of the door slides sown, and the upper part of the door slides up parallel to the outside of the vehicle.

U.S. Pat. No. 5,921,611 to “Upwardly Retracting Vehicle Door” describes a door for the rear of a minivan where the back door and window slide upward into a pocket in the vehicle roof.

U.S. Pat. Nos. 5,378,036 and 5,524,960 “Sliding Automobile Door” both describe an automobile passenger door that slides in a vertical direction.

U.S. Pat. No. 7,147,267 “Device for Pivoting a Vehicle Door or a Vehicle Lid” describes a “universal joint” type apparatus for pivoting the door.

Nowhere in the prior art is found a vehicle door design similar to the instant invention.

### SUMMARY OF THE PRESENT INVENTION

The present invention provides a vehicle door that opens from a point of rotation on the door in a scissors like motion. The door design of the present invention is suitable for any type of vehicle including, but not limited to: four door passenger vehicle, four door sedan, two door coupe, two or four door convertible, pick up trucks, vans, minivans, and minibuses.

The vehicle door of the present invention provides better aerodynamics, a more aesthetically pleasing profile, and an easier ingress and egress for passengers. This feature is especially useful for elderly or persons having physically impairments.

Other benefits of the car door of the present invention include saving space in crowded parking spaces in parking lots, driveways and small or standard garages without the worry or cost of dents, dings and scratches. An additional advantage of the car door of the present invention is the door will not open into traffic or crowded sidewalks. The present invention will increase the ease of entering and exiting the vehicle. A vehicle equipped with the door of the present invention can be parked within 12 inches of another vehicle or any other obstruction and the passenger(s) will be able to comfortably exit or enter the vehicle.

The door can be ergonomically engineered for anyone to open and shut with utmost ease. The doors can also be engineered to open automatically, or shut with a remote control device.

### BRIEF DESCRIPTION OF THE DRAWINGS

FIG. 1 depicts a side view of the vehicle door of the present invention on a four door vehicle.

FIG. 2 depicts a side view of an alternative embodiment of the vehicle door of the present invention on a four door vehicle.

FIG. 3 depicts a side view of the vehicle door of the present invention on a convertible.

FIG. 4 depicts a side view of an alternative embodiment of the vehicle door of the present invention on a convertible.

FIG. 5 depicts a side view of the vehicle door of the present invention on a pick-up truck.

FIG. 6 depicts a side view of an alternative embodiment of the vehicle door of the present invention on a pick-up truck

### DETAILED DESCRIPTION OF THE INVENTION

As used herein, the term “upper” refers to the top half or top 50% of the door. As used herein, the term “lower” refers to the bottom half, or bottom 50% of the door. As used herein the term “rear” refers to the back half, or back 50% of the door. As used herein, the term “front” refers to the front half, or front 50% of the door of the vehicle.

The vehicle door of the present invention provides advantages over conventional double hinged doors. The vehicle door of the present invention can be opened in a swivel, upward motion which clears the front corner panels of the vehicle when engaged. When the door is unlatched, the pivoting swivel point 10 will move away from the body of the vehicle sufficiently to clear the corner panel and swivel upward.

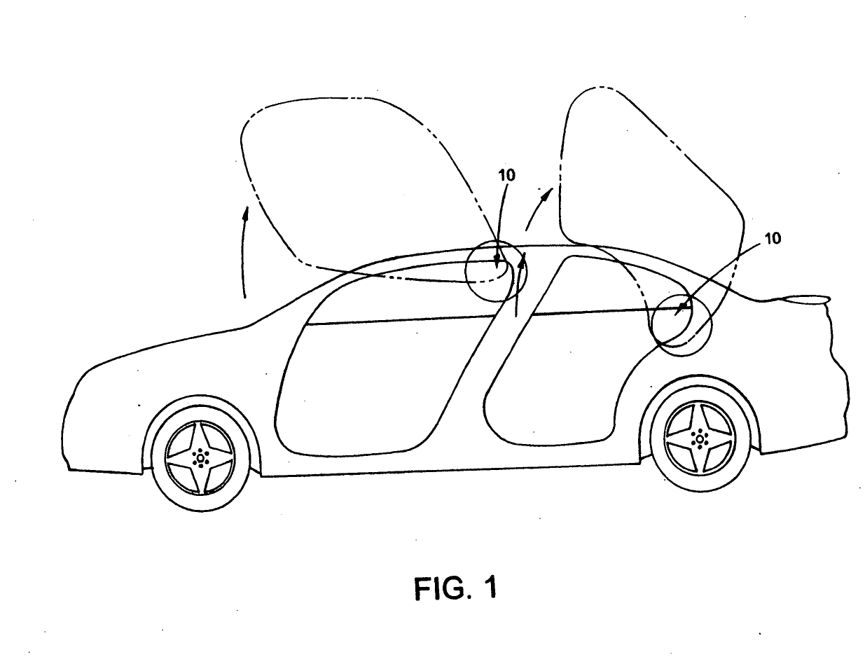

Referring to FIG. 1, a four door vehicle is depicted where the driver's door and front passenger's door is shown to pivot from pivoting swivel point 10 located at the upper rear portion of the door. The driver's door pivots from the upper rear of the door and opens from the top in an upward scissors like motion traveling along an arcuate path which parallels the curvature of the side of the vehicle. The rear passenger door is shown to pivot from pivoting swivel point 10 also located at the upper rear of the door. The passenger's door pivots from the upper rear of the door and opens from the top in an upward scissors like motion traveling along an arcuate path which parallels the curvature of the side of the vehicle.

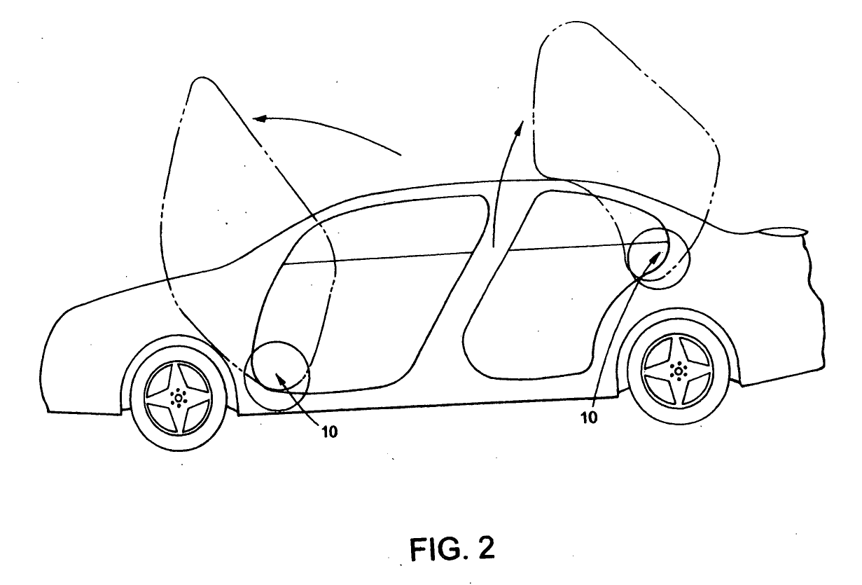

Referring to FIG. 2, a four door vehicle is depicted where the driver's door and front passenger's door is shown to pivot from pivoting swivel point 10 located at the lower front portion of the door. The door pivots from the lower front of the door and opens from bottom to top in an upward scissors like motion traveling along an arcuate path which parallels the curvature of the side of the vehicle. The door can be mounted at any point so that when fully opened the bottom of the door is completely out of the way of the entrance of the vehicle. The rear passenger door is shown to pivot from pivoting swivel point 10 also located at the upper rear of the door. The door pivots from the upper rear portion of the door and opens from the top in an upward scissors like motion traveling along an arcuate path which parallels the curvature of the side of the vehicle.

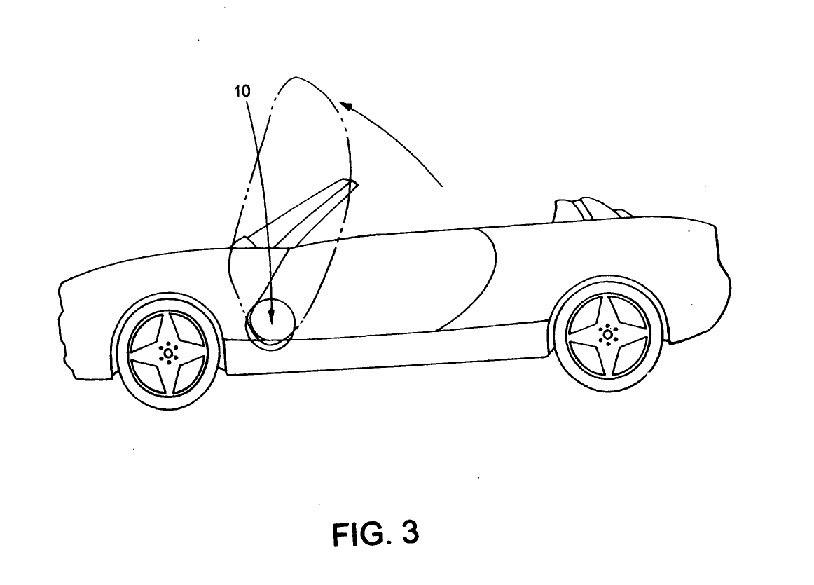

Referring to FIG. 3, a two door convertible is depicted wherein the driver's door and passenger's door is shown to pivot from the pivoting swivel point 10 located at the lower front portion of the door. The door pivots from the lower front of the door and opens from bottom to top in an upward scissors like motion traveling along an arcuate path which parallels the curvature of the side of the vehicle. The door can be mounted at any point so that when fully opened the bottom of the door is completely out of the way of the entrance of the vehicle.

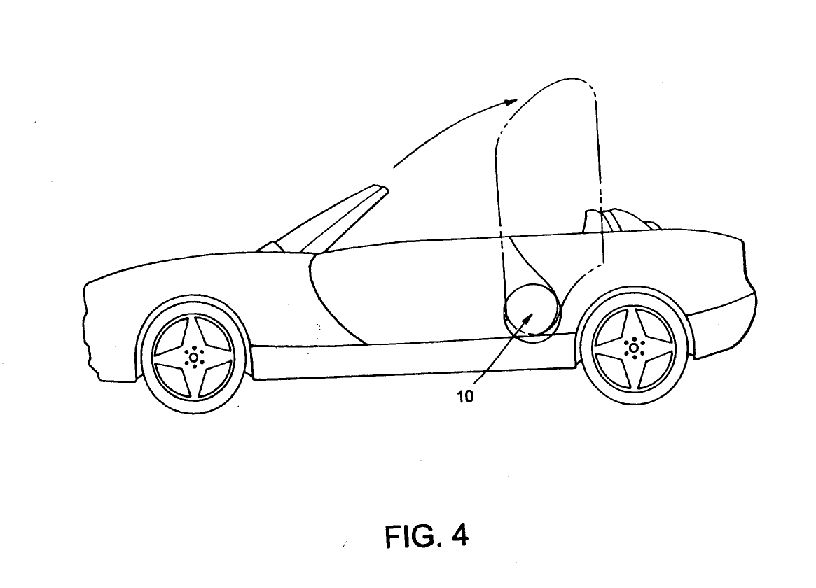

Referring to FIG. 4, a two door convertible is depicted wherein the driver's door and passenger's door is shown to pivot from the pivoting swivel point 10 located at the lower rear portion of the door. The door pivots from the lower rear of the door and opens from bottom to top in an upward scissors like motion traveling along an arcuate path which parallels the curvature of the side of the vehicle

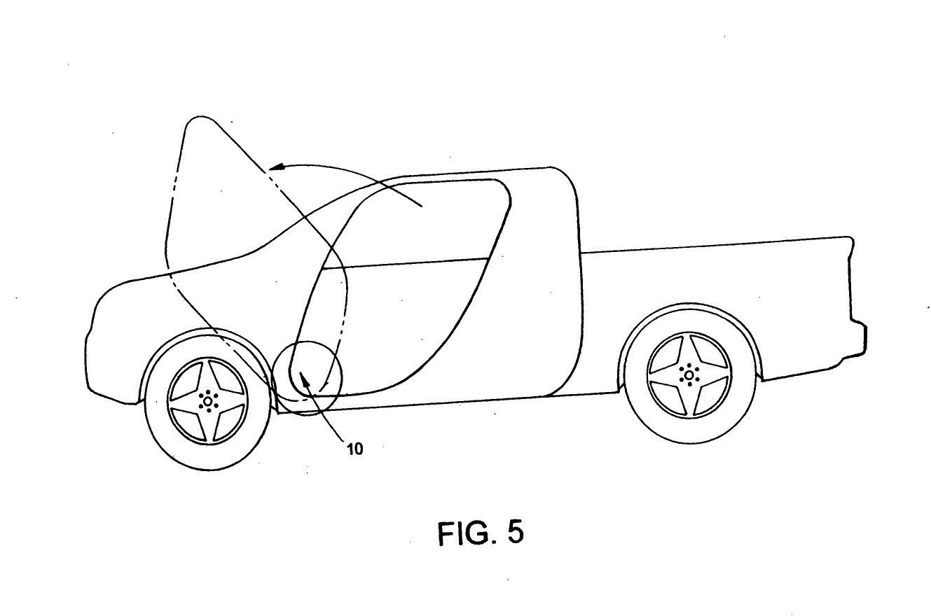

Referring to FIG. 5, a pick-up truck is depicted wherein the driver's door and the passenger's door is shown to pivot from the pivoting swivel point 10 located at the lower front portion of the door. The door pivots from the lower front of the door and opens from bottom to top in an upward scissors like motion traveling along an arcuate path which parallels the curvature of the side of the vehicle. The door can be mounted at any point so that when fully opened the bottom of the door is completely out of the way of the entrance of the vehicle.

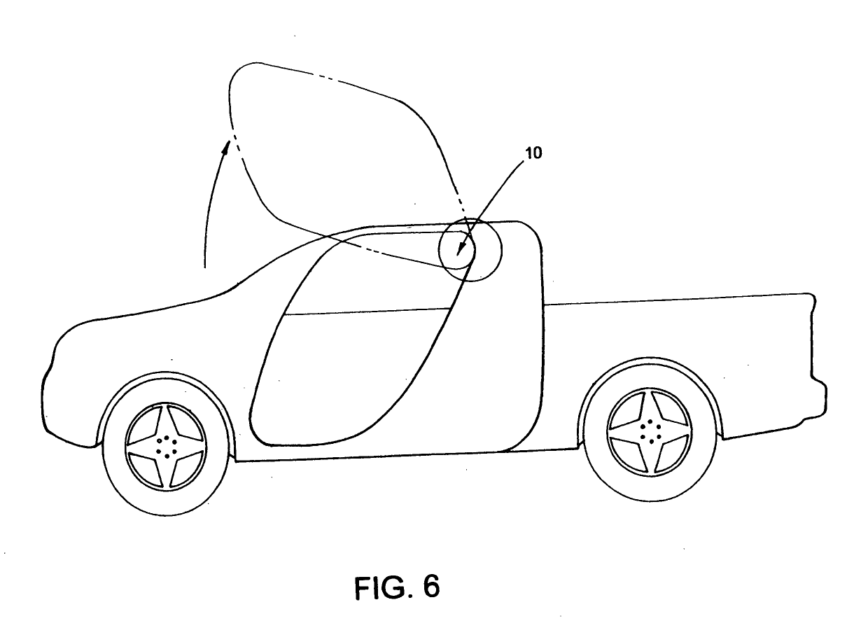

Referring to FIG. 6, a pick-up truck is depicted wherein the driver's door and the passenger's door is shown to pivot from the pivoting swivel point 10 located at the upper rear portion of the door. The door pivots from the upper rear portion of the door and opens from the top in an upward scissors like motion traveling along an arcuate path which parallels the curvature of the side of the vehicle.

The arcuate path traversed by the door should be about from one to about three inches away from the body of the vehicle.

It is important to note that the door should completely clear any corner panel, whether front or rear, when opening. When the door is unlatched, the door should move away from the body of the vehicle from about one to about three inches to assure adequate tolerance in clearing the body of the vehicle.

An alternative embodiment for doors opening from a lower pivoting swivel point would be to design the door to traverse a path so that it opens at an angle of about 1 to about 15 degrees from the body of the vehicle.

The doors will be equipped with an additional handle near the lower edge so that a person can easily reach the handle and close the door from inside the vehicle.

The hinge can comprise a threaded unit or threaded cylindrical member so that the door rotates and moves away from the body of the vehicle when the door is unlatched in an unscrew type motion, allowing the car door to spin away from any corner panel thus clearing the entryway to the vehicle. Conversely, when closing the door, the opposite happens, as the driver or passenger closes the door, the threaded unit or threaded cylindrical member will spin shut in a screw inward motion and proceed to shut and latch the door. The unlatching or opening of the doors from the inside of the vehicle can be easily achieved. The driver or passenger need only give a slight pull upward to unlatch, then continue to pull upward slightly and then the door will continue to completely rotate on its own until it stops at the appropriate position. This can be accomplished through the use of spring action, shock absorption, hydraulic, motorized, air, electrical, gravity or other unmanned force or means.

To close and shut the car door when it is opened while the driver or passenger is inside the vehicle, just the opposite happens; the driver or passenger grabs hold of the same latch handle and slightly pulls downward to about chest height or dashboard height and then the car door will continue to gently shut on its own. This can be accomplished through the use of spring action, shock absorption, hydraulic, motorized, air, electrical, gravity or other unmanned force or means.

The unlatching of the doors from the outside of the vehicle can also be also done. The driver or passenger gives a slight pull upward to unlatch, then continue to pull upward slightly up to chest height and then the door will continue to completely rotate on its own until it stops at the appropriate position.

To close and shut the car door when it is opened while outside, just the opposite happens; the driver or passenger grabs hold of the same latch handle and slightly pulls downward to about chest height or dashboard height and then the car door will continue to gently shut on its own. This can be accomplished through the use of spring action, shock absorption, hydraulic, motorized, air, electrical, gravity or other unmanned force or means.

An alternative embodiment would include a button inside the vehicle to activate the door opening or closing when the button is pressed.

Another feature can be added as an option is the use of a remote control key fob. One can be near the vehicle and remotely unlatch the door of the vehicle from a distance as well as latch the vehicle door from a distance. This feature can also include automatic open and close to completion without the aid of the driver or passenger using only the key fob.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vehicle door for a vehicle wherein the door opens from a point of rotation pivot swivel point located on the door and the door opens in an upward scissors like motion traveling along an arcuate path which parallels the curvature of the side of the vehicle.

2. The vehicle door of claim 1 wherein the vehicle is a four door vehicle, and wherein the drivers door and the front passenger door opens from a point of rotation pivot swivel point located in the upper rear of the door and opens from the top in an upward scissors like motion traveling along an arcuate path which parallels the curvature of the side of the vehicle.

3. The vehicle door of claim 1 wherein the vehicle is a four door vehicle, and wherein the drivers door and the front passenger door opens from a point of rotation pivot swivel point located in the lower rear of the door and opens from the top in an upward scissors like motion traveling along an arcuate path which parallels the curvature of the side of the vehicle.

4. The vehicle door of claim 1 wherein the vehicle is a four door vehicle, and wherein the rear passenger door opens from a point of rotation pivot swivel point located in the upper rear of the door and opens from the top in an upward scissors like motion traveling along an arcuate path which parallels the curvature of the side of the vehicle.

5. The vehicle door of claim 1 wherein the vehicle is a two door convertible vehicle, and wherein the drivers door and the passenger door opens from a point of rotation pivot swivel point located in the lower rear of the door and opens from the top in an upward scissors like motion traveling along an arcuate path which parallels the curvature of the side of the vehicle.

6. The vehicle door of claim 1 wherein the vehicle is a pick up truck vehicle, and wherein the drivers door and the passenger door opens from a point of rotation pivot swivel point located in the lower front of the door and opens from the bottom in an upward scissors like motion traveling along an arcuate path which parallels the curvature of the side of the vehicle.

7. The vehicle door of claim 1 wherein the vehicle is a pick up truck vehicle, and wherein the drivers door and the passenger door opens from a point of rotation pivot swivel point located in the upper rear of 0. the door and opens from the bottom in an upward scissors like motion traveling along an arcuate path which parallels the curvature of the side of the vehicle.
